(19) United States
(12) Patent Application Publication
(10) Pub. No.: US 2010/0156613 A1
(43) Pub. Date: Jun. 24, 2010

(54) APPARATUS FOR COMMUNICATING WITH RFID TAG

(75) Inventors: Hironori Hirata, Nagoya-shi (JP); Yasuhisa Ichikawa, Nagoya-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA, Nagoya-shi (JP)

(21) Appl. No.: 12/718,021

(22) Filed: Mar. 5, 2010

Related U.S. Application Data
(63) Continuation-in-part of application No. PCT/JP2008/066326, filed on Sep. 10, 2008.

(30) Foreign Application Priority Data
Sep. 28, 2007 (JP) 2007-253496

(51) Int. Cl. H04Q 5/22

(52) U.S. Cl. 340/10.42; 340/10.6

(57) ABSTRACT

This disclosure discloses an apparatus for communicating with an RFID tag comprising: a radio communicating device configured to conduct radio communication with a plurality of RFID tag circuit elements respectively having an IC circuit part storing information and a tag antenna capable of transmission and reception of information; and a mode setting portion capable of switching and setting from a plurality of application modes with use forms of said radio communication different from each other according to status information indicating a status with respect to an obtainment of identification information of the plurality of said RFID tag circuit elements in communication.

### CROSS-REFERENCE TO RELATED APPLICATION

This is a CIP application PCT/JP2008/66326, filed Sep. 10, 2008, which was not published under PCT article 21(2) in English.

### BACKGROUND OF THE INVENTION

1. Field of the Invention

The present invention relates to an apparatus for communicating with a radio frequency identification (hereinafter referred to as RFID) tag configured to conduct radio communication with a communication target.

2. Description of the Related Art

A radio communication system configured to conduct radio communication with a communication target has been already known. Recently, as one of this radio communication system, an RFID system is proposed. The RFID system is a system in which information reading and writing is performed in a non-contact manner between an RFID tag that includes an RFID tag circuit element and a reader/writer. The RFID tag circuit element has an IC circuit part storing predetermined RFID tag information and a tag antenna connected to this IC circuit part for information transmission and reception. This RFID system has been put into practical use in various fields.

A prior-art reference of the RFID system in which a mode is switched by a control signal from the reader/writer as an apparatus for communicating with an RFID tag to an IC tag that includes the RFID tag circuit element has been already known. That is, the RFID tag circuit element is switched to either of a short-distance mode in which a response is made only if intensity of a radio wave is not less than prescribed or a long-distance mode in which a response is made in any case without limitation on the radio wave intensity. For example, if an article attached with the RFID tag circuit element is transported by a truck, for example, the RFID tag circuit element is switched to the short-distance mode. As a result, reading of the RFID tag information for illegal purpose from outside the car can be prevented.

With the recent progress in the practical use of the RFID system in various fields, a use mode of the apparatus for communicating with an RFID tag configured to read and write information with respect to the RFID tag circuit element has been diversified. For example, the apparatus for communicating with an RFID tag might be fixed at a predetermined position for use or the apparatus for communicating with an RFID tag might be carried by an operator such that the operator uses it while carrying it around. Also, there can be various use modes such that a search is made for a single or a plurality of RFID tag circuit elements, only presence of a plurality of RFID tag circuit elements specified in advance is checked, and all the RFID tag circuit elements present in a communication range of the apparatus for communicating with an RFID tag are searched and listed up, for example. In these various use modes, in order to realize the optimal communication between the apparatus for communicating with an RFID tag and the RFID tag circuit element, a communication mode on the apparatus for communicating with an RFID tag side needs to be switched according to the use mode. However, in the prior art reference, switching of the communication mode on the apparatus for communicating with an RFID tag side has not been considered at all.

### SUMMARY OF THE INVENTION

The present invention has an object to provide an apparatus for communicating with an RFID tag that can easily conduct radio communication in the optimal communication mode.

There is provided an apparatus for communicating with an RFID tag comprising: a radio communicating device configured to conduct radio communication with a plurality of RFID tag circuit elements respectively having an IC circuit part storing information and a tag antenna capable of transmission and reception of information; and a mode setting portion capable of switching and setting from a plurality of application modes with use forms of the radio communication different from each other according to status information indicating a status with respect to an obtainment of identification information of the plurality of the RFID tag circuit elements in communication.

### BRIEF DESCRIPTION OF THE DRAWING

FIG. 1 is a diagram illustrating an example of a use mode of an apparatus for communicating with an RFID tag of an embodiment of the present invention.

FIG. 2A is a diagram illustrating an entire structure in a handheld use state of a reader/writer.

FIG. 2B is a diagram illustrating an entire structure in a fixed use state of the reader/writer.

FIG. 3A is a functional block diagram illustrating a functional configuration in the handheld use state of the reader/writer and a cradle.

FIG. 3B is a functional block diagram illustrating a functional configuration in the fixed use state of the reader/writer and a cradle.

FIG. 4 is a block diagram illustrating an example of a functional configuration of an RFID tag circuit element.

FIG. 5 is a time chart of a signal transmitted and received between the reader/writer and a single RFID tag circuit element.

FIG. 6 is a flowchart illustrating a control procedure a control circuit of the reader/writer executes.

FIG. 7 is a flowchart illustrating a detailed procedure of list-up mode processing.

FIG. 8 is a flowchart illustrating a detailed procedure of single search mode processing.

FIG. 9 is a flowchart illustrating a detailed procedure of multi search mode processing.

FIG. 10 is a flowchart illustrating a detailed procedure of inventory mode processing.

FIG. 11 is a flowchart illustrating a control procedure a control circuit of a reader/writer executes in a variation in which the latest tag ID list is detected.

FIG. 12 is a flowchart illustrating a control procedure a control circuit of a reader/writer executes in a variation in which an obtainment origin of the list is determined.

FIG. 13 is a flowchart illustrating a control procedure a control circuit of a reader/writer executes in another variation in which an obtainment origin of the list is determined.

### DETAILED DESCRIPTION OF THE PREFERRED EMBODIMENTS

An embodiment of the present invention will be described below referring to the attached drawings.

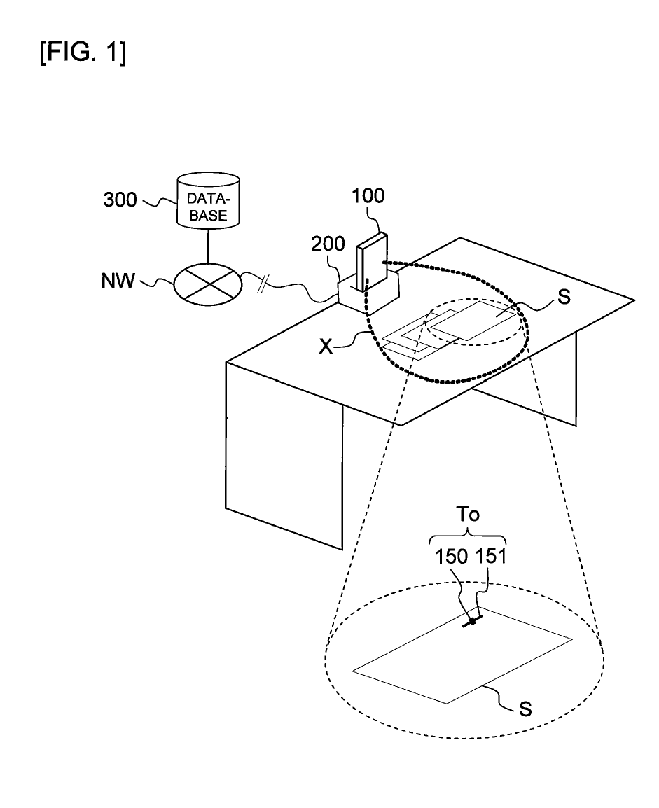

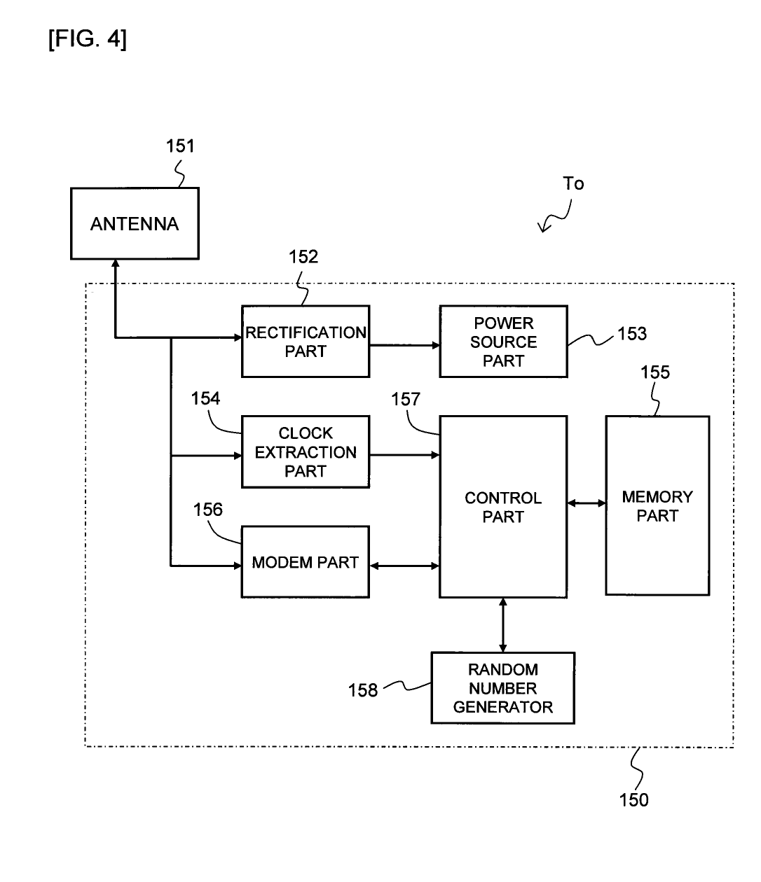

In an example shown in FIG. 1, the apparatus for communicating with an RFID tag is applied to an article search in an office. That is, a plurality of documents S are placed on a desk, and the RFID tag circuit element To (See FIG. 4, which will be described later) is attached to each of the documents S. The RFID tag circuit element To includes an IC circuit part 150 storing information and a tag antenna 151 capable of information transmission and reception. A reader/writer 100, which is an apparatus for communicating with an RFID tag in this embodiment, performs information transmission and reception via radio communication with the plurality of RFID tag circuit elements To on the documents S present in a communicable area X. An operator of this reader/writer 100 is a person who makes a search of the necessary document S, for example. The reader/writer 100 is a handheld type. The operator can carry the reader/writer 100 around for use, not by placing it at a placing spot, for example. Such use form is referred to as “handheld use” below as appropriate. Also, the operator can use the reader/writer 100 as shown in FIG. 1 by placing it at the placing spot. Such a use form is referred to as “fixed use” below as appropriate. In the case of the fixed use, the reader/writer 100 is used in a state attached to a cradle 200. By being attached to the cradle 200, the reader/writer 100 can connect to a database 300, which is a first storage device disposed in a server, not shown, for example, through a network NW.

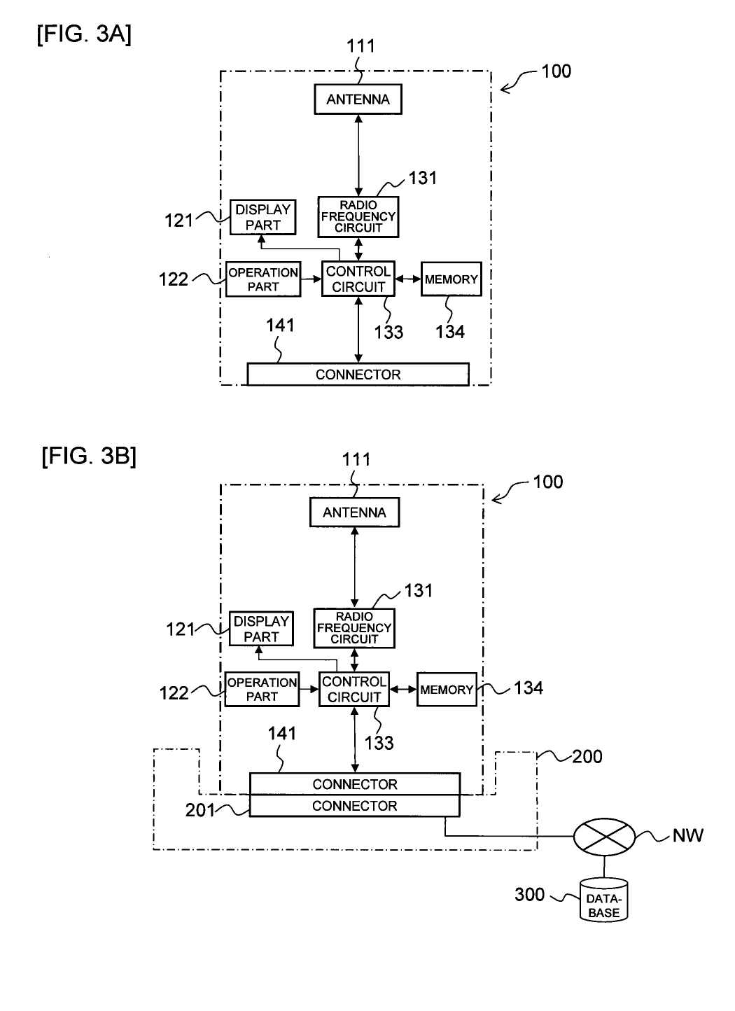

In the case of the fixed use, the reader/writer 100 obtains a list of tag IDs (which will be described later) relating to the one or more documents S, which is a search target, in advance from the database 300 through the network NW. In the case of the handheld use, the list of the tag IDs is obtained from a memory 134 (See FIG. 3, which will be described later) in the reader/writer 100. After the list has been obtained as above, the reader/writer 100 transmits and receives information via radio communication to and from the RFID tag circuit element To attached to each of the documents S. As a result, the reader/writer 100 makes a search to see if each document S set in the list is present in the communicable area X or not. As a mode of the radio communication the reader/writer 100 executes at this time, three communication modes, that is, a single search mode, a multi search mode, and an inventory mode are prepared. Also, the reader/writer 100 can prepare a list of the tag IDs relating to the document S present in the communicable area X by making a search without an input of the above list of search targets. At this time, as the mode of radio communication the reader/writer 100 conducts, a list-up mode is prepared. These four modes will be described later in detail.

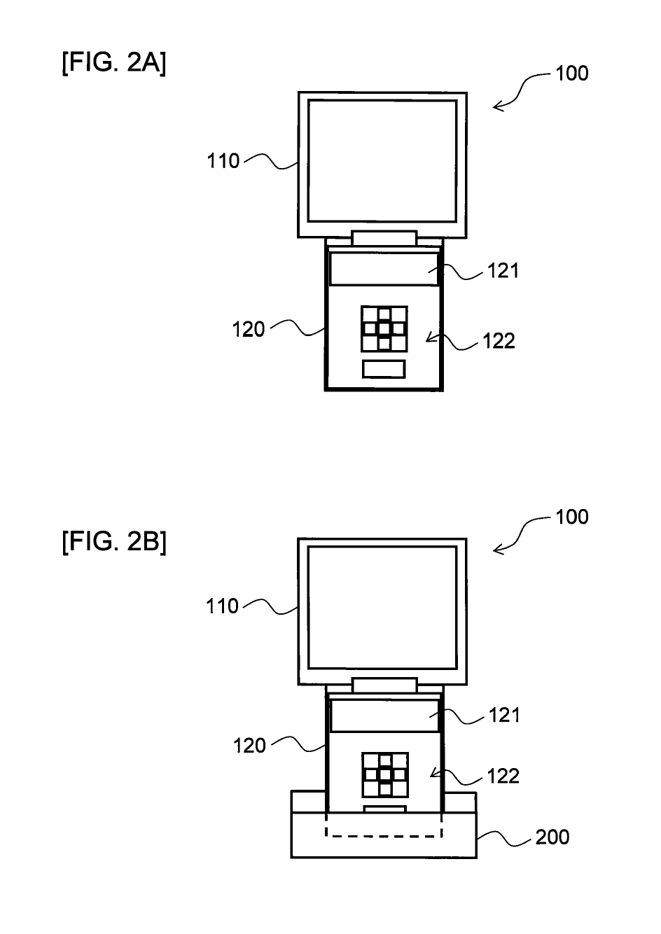

An appearance of the reader/writer 100 will be described referring to FIGS. 2A and 2B. FIG. 2A shows a state of the handheld use, in which the reader/writer 100 is not attached to the cradle 200 but carried by the operator for use. FIG. 2B shows a state of the fixed use, in which the reader/writer 100 is placed at the placing spot in a state attached to the cradle 200 for use.

The reader/writer 100 includes an antenna part 110 and a main body part 120. The antenna part 110 includes a reader antenna 111 (See FIG. 3, which will be described later) configured to conduct radio communication. The main body part 120 is disposed at a lower part of the antenna part 110. The main body part 120 has a display part 121 as a display device and an operation part 122 as an operating device into which an operator makes various operation inputs. The display part 121 is arranged on an upper side of the main body part 120 and displays various kinds of information. The operation part 122 is arranged on a lower side of the display part 121.

A functional configuration of the reader/writer 100 will be described using FIGS. 3A and 3B. FIG. 3A shows a state of the handheld use, while FIG. 3B shows a state of the fixed use.

The reader/writer 100 has the display part 121, the operation part 122, the reader antenna 111 constituting a part of the radio communicating device, a radio frequency circuit 131 constituting a part of the radio communicating device, a control circuit 133, the memory 134 as a second storage device, and a connector 141.

The reader antenna 111 transmits and receives a signal via radio communication with the RFID tag circuit element To as a communication target. The radio frequency circuit 131 accesses the IC circuit part 150 of the RFID tag circuit element To through the reader antenna 111 via radio communication and processes a signal read of the RFID tag circuit element To. The control circuit 133 executes control of the entire reader/writer 100 including the radio frequency circuit 131.

The memory 134 stores a list of tag IDs (hereinafter referred to as a “tag ID list” as appropriate), which is identification information of the plurality of RFID tag circuit elements To as search targets, for example. This tag ID list is stored in the memory 134 by operator, who inputs the list through the operation part 122 in advance. The memory 134 is a RAM and a hard disk, for example.

The connector 141 is connected to a connector 201 disposed in the cradle 200 during the fixed use.

As shown in FIG. 3B, during the fixed use, the reader/writer 100 is attached to the cradle 200, and the connector 141 and the connector 201 are connected to each other. As a result, the control circuit 133 is connected to the database 300 through the network NW. As a result, the reader/writer 100 obtains the tag ID list of the plurality of RFID tag circuit elements To as search targets stored in the database 300. Similarly to the list in the memory 134, the operator registers the tag ID list in the database 300 in advance.

The RFID tag circuit element To has, as shown in FIG. 4, the tag antenna 151 configured to perform transmission and reception of a signal in a non-contact manner with the reader antenna 111 and the IC circuit part 150.

The IC circuit part 150 includes a rectification part 152, a power source part 153, a clock extraction part 154, a memory part 155, a modem part 156, a random number generator 158 (the details will be described later), and a control part 157. The rectification part 152 rectifies an interrogation wave, which is an interrogation signal, received by the tag antenna 151. The power source part 153 accumulates energy of the interrogation wave rectified by the rectification part 152 and uses the energy as a driving power source of the RFID tag circuit element To. The clock extraction part 154 extracts a clock signal from the interrogation wave received by the tag antenna 151 and supplies the signal to the control part 157. The memory part 155 stores a predetermined information signal. The random number generator 158 generates a random number at reception of the interrogation signal from the reader/writer 100. By this random number, to which identification slot a response signal is to be outputted is determined. The details of the interrogation signal and the identification slot will be described later. The control part 157 controls operations of the RFID tag circuit element To through the memory part 155, the clock extraction part 154, the random number generator 158, and the modem part 156, for example.

The modem part 156 demodulates an interrogation wave from the reader antenna 3 of the reader/writer 100, received by the tag antenna 151. The modem part 156 also modulates a reply signal from the control part 157 and transmits it as a response wave, that is, a signal including the tag ID, from the tag antenna 151.

The clock extraction part 154 extracts a clock component from the received signal and supplies a clock corresponding to a frequency of the clock component of the received signal to the control part 157.

The random number generator 158 generates a random number from 0 to 2^{Q}−1 to a slot number specified value Q specified in the interrogation signal from the reader/writer 100. The details will be described later.

The control part 157 interprets a received signal demodulated by the modem part 156 and generates a reply signal on the basis of the information signal stored in the memory part 155. Then, the modem part 156 transmits the reply signal through the tag antenna 151 in an identification slot corresponding to the random number generated by the random number generator 158.

Here, the most distinctive characteristic of the reader/writer 100 of this embodiment is that a plurality of application modes can be switched and set according to status information indicating an obtainment status of the tag IDs of the plurality of RFID tag circuit elements To in communication. The plurality of application modes are set so that application forms of radio communication are different from each other. Also, the status information includes an obtainment origin of the tag ID list as obtainment origin information and a status of a tag ID list including the number of the tag IDs and presence of information, for example. The details will be sequentially described below.

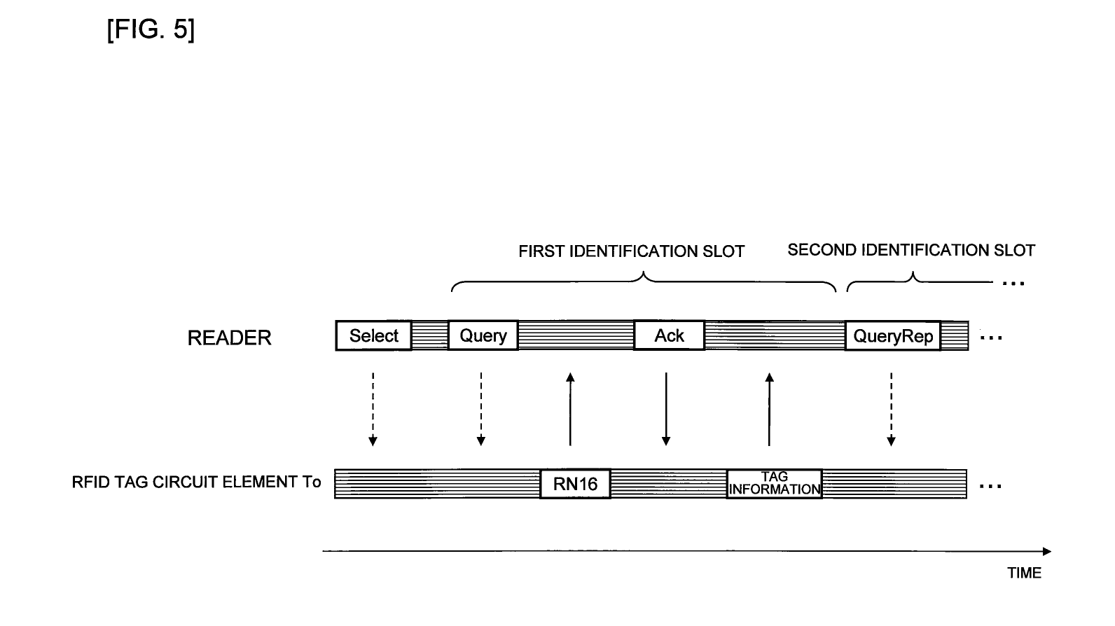

First, a signal transmitted and received between the reader/writer 100 and the RFID tag circuit element To and a method of transmission and reception thereof will be described using the international standard ISO/IEC 18000-6 Type C protocol as an example and using FIG. 5. The method of transmitting and receiving a signal shown in FIG. 5 is based on the known Random-Slotted Collision arbitration method, and a change over time is from the left side to the right side in the figure. Also, arrows shown between the reader/writer 100 and the RFID tag circuit element To indicate a transmission direction of the signal. A broken line indicates a case in which the other party of transmission is not specified, while a solid line indicates a case in which the other party of transmission is specified.

In FIG. 5, the reader/writer 100 first transmits a “Select” command to all the RFID tag circuit elements To present in the communicable area X. This “Select” command is a command to specify a condition of the RFID tag circuit element To with which the reader/writer 100 conducts radio communication after that. By means of this “Select” command, various conditions are specified, the number of RFID tag circuit elements To whose information is to be read is limited, and efficiency of the radio communication is improved. Only the RFID tag circuit elements To satisfying the specified conditions in the RFID tag circuit elements To having received the “Select” command can conduct radio communication after that. In FIG. 5, only one RFID tag circuit element To satisfying the conditions is shown.

Subsequently, the reader/writer 100 transmits a “Query” command as a reading command to the RFID tag group. This “Query” command is a command to request response and transmission of tag information including the tag ID from each of the RFID tag circuit elements To and a command to make a search under a condition that the number of the RFID tag circuit elements To expected to respond is not specified. This “Query” command includes a slot number specified value Q to specify a predetermined number, that is, any of values from 0 to 15, for example. If the “Query” command is transmitted from the radio frequency circuit 131 through the reader antenna 111, each of the RFID tag circuit elements To creates random numbers from 0 to 2^{Q}−1, that is, up to Q power of 2−1 by the random-number generator 158 and maintains them as slot count values S.

After transmitting the “Query” command through the reader antenna 111, the reader/writer 100 waits for a response from the RFID tag circuit element To in a predetermined identification slot. This identification slot is a timeframe divided in a predetermined period after the “Query” command or a “QueryRep” command, which will be described later, is first transmitted. The identification slot is usually repeated continuously for a predetermined number of times. Specifically, a single session of a first identification slot of the “Query” command and 2^{Q}−1 sessions of a second identification slot and after of the “QueryRep” command, totaling in 2^{Q} times, are continuously repeated.

In the RFID tag circuit elements To in the RFID tag group, the RFID tag circuit element To having created a value 0 as the slot count value S after having received the “Query” command responds in the first identification slot containing this “Query” command. At this time, the RFID tag circuit element To transmits an “RN16” command using a pseudo random number of 16 bits, for example, to the reader/writer 100 in order to obtain permission to transmit the tag information as a response signal.

The reader/writer 100 having received the “RN16” command transmits an “Ack” command to permit transmission of the tag information with the contents corresponding to the “RN16” command. The RFID tag circuit element To having received the “Ack” command determines if the received “Ack” command corresponds to the “RN16” command transmitted by the RFID circuit element To before so that they satisfy the predetermined conditions, respectively.

If it is determined that the both correspond to each other, the RFID tag circuit element To considers that the transmission of its own tag information is permitted and transmits the tag information containing the tag ID. As described above, transmission and reception of a signal in a single identification slot is performed.

After that, in the second identification slot and after, the reader/writer 100 transmits the “QueryRep” command instead of the “Query” command and waits for a response of the other RFID tag circuit elements To, not particularly shown, in the identification slot timeframe provided immediately after that. Each RFID tag circuit element To having received the “QueryRep” command subtracts its own slot count value S only by 1 and maintains the value. Each RFID tag circuit element To conducts transmission and reception of a signal including the “RN16” command with the reader/writer 100 in the identification slot at the time when the slot count value S becomes a value 0.

In each identification slot, if there is no RFID tag circuit element with the slot count value S of 0, transmission and reception is not conducted except the “Query” command or “QueryRep” command, and the identification slot is finished, after a predetermined timeframe has elapsed.

As described above, each RFID tag circuit element To replies a response signal in a different identification slot. As a result, the reader/writer 100 is not affected by interference but can clearly receive and take in the tag information of the respective RFID tag circuit elements To through the reader antenna 111.

As described above, the total number of the identification slots is usually 2^{Q}. In this description, a processing unit combining the processing in the first identification slot in a single session starting with transmission of the “Query” command and the processing in the identification slot in the 2^{Q}−1 session starting with transmission of the “QueryRep” command in the second identification slot and after is referred to as “reading trial processing” below as appropriate. Also, in this description, the number of times that the reader/writer 100 executes the reading trial processing is referred to as the “reading trial number” below as appropriate.

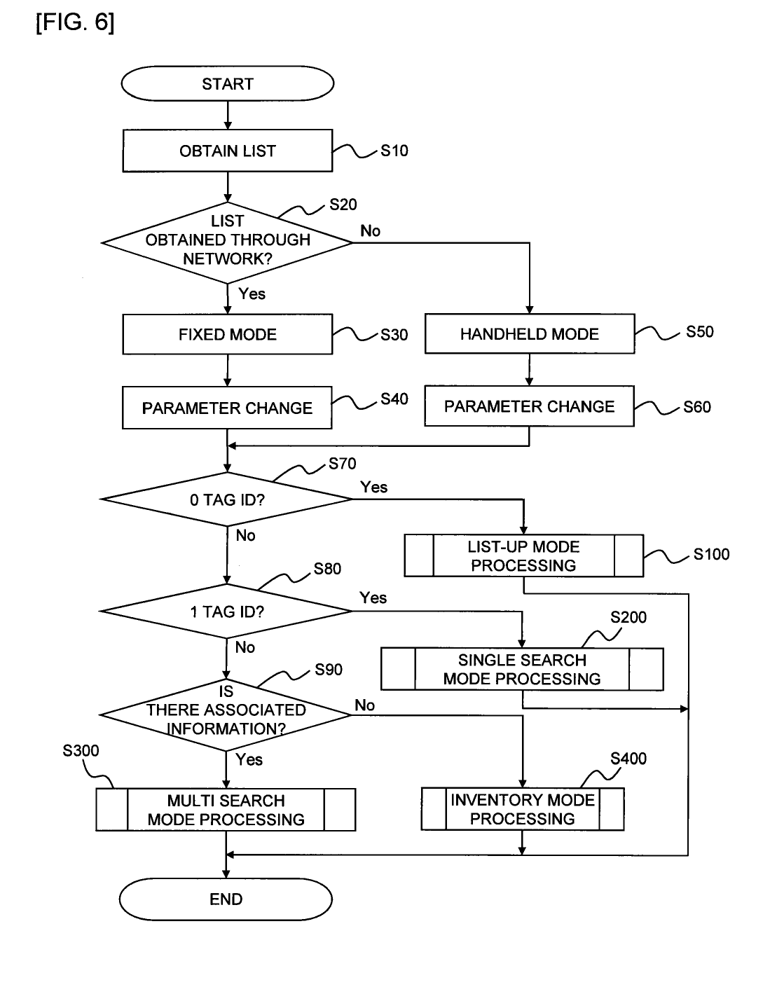

A control procedure the control circuit 133 of the reader/writer 100 executes will be described referring to FIGS. 6 to 10. If the reader/writer 100 is powered on, a flow shown in FIG. 6 is started. Alternatively, when an operation is performed to start the reading processing of the RFID tag circuit element To in the operation part 122, for example, the flow shown in FIG. 6 is started.

First, at Step S10, the control circuit 133 obtains a tag ID list including tag IDs of the plurality of RFID tag circuit elements To as search targets. Specifically, the control circuit 133 searches and obtains the memory 134 if the reader/writer 100 is in a handheld use state. If the reader/writer 100 is in the fixed use state, the control circuit 133 searches the database 300 connected through the cradle 200 and the network NW and obtains the tag ID list.

At Step S20, the control circuit 133 determines if the tag ID list has been obtained through the network NW at Step S10 or not. If the list has been obtained through the network NW, the determination at Step S20 is satisfied, and the routine goes to Step S30, and the reader/writer 100 is changed to a fixed mode. This fixed mode is one of specification modes relating to operation specifications of the reader/writer 100 and a mode corresponding to the fixed use. Then, at Step S40, the control circuit 133 changes the communication parameters to values corresponding to the fixed mode.

On the other hand, at Step S20, if the tag ID list has not been obtained through the network NW, that is, if it is obtained from the memory 134, the determination at Step S20 is not satisfied and the routine goes to Step S50. At Step S50, the reader/writer 100 is changed to the handheld mode. This handheld mode is one of the specification modes relating to the operation specifications of the reader/writer 100 and is a mode corresponding to the handheld use. Then, at Step S60, the control circuit 133 changes the communication parameter to values corresponding to the handheld mode.

An example of the communication parameter change includes increase and decrease of a power, for example. As described above, if the apparatus is used for an article search in an office, in the fixed use, since it is only necessary that the communication range covers the space above the desk, the control circuit 133 decreases the power. On the other hand, in the handheld use, since there is a possibility that the operator makes an article search far from the desk, the control circuit 133 increases the power. As a result, the optimal communication characteristics according to the use state of the reader/writer 100 can be obtained. As the communication parameter, a communication frequency, a communication speed, and a transfer method of the obtained information, for example, may be changed other than the above.

At Step S70, the control circuit 133 determines if the number of tag IDs of the RFID tag circuit elements To included in the list obtained at Step S10 is 0 or not. If no tag ID is registered in the list, the determination is satisfied, the routine goes to Step S100, and the control circuit 133 executes list-up mode processing corresponding to the list-up mode, which will be described later. After that, this flow is finished.

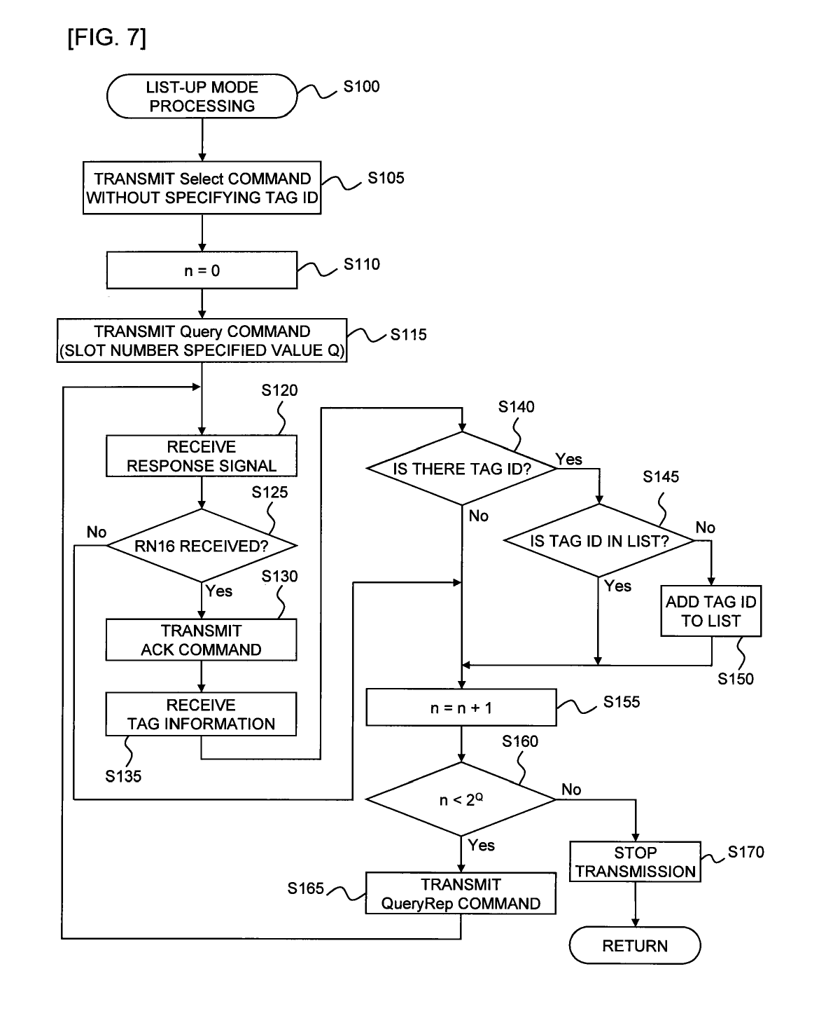

The list-up mode is one of plural types of the application modes relating to the application forms of the reader/writer 100 and is a mode for obtaining the tag IDs via radio communication from the RFID tag circuit elements To not registered in the list and listing them up. The list-up mode processing is processing corresponding to the list-up mode. In the list-up mode processing, in a state in which the operator does not specify the RFID tag circuit element To as a search target, the reader/writer 100 conducts radio communication with the RFID tag circuit elements To present within the communicable area X. Then, the reader/writer 100 lists up all the tag IDs of all the detected RFID tag circuit elements To or the associated information, which will be described later, relating to the tag IDs (See FIG. 7, which will be described later).

On the other hand, at Step S70, if at least one tag ID is registered in the list, the determination at Step S70 is not satisfied, and the routine goes to Step S80.

At Step S80, the control circuit 133 determines if the number of tag IDs included in the list obtained at Step S10 is 1 or not. If the number of tag IDs included in the list is 1, the determination is satisfied, and the routine goes to Step S200, and the control circuit 133 executes single search mode processing corresponding to the single search mode, which will be described later. After that, this flow is finished.

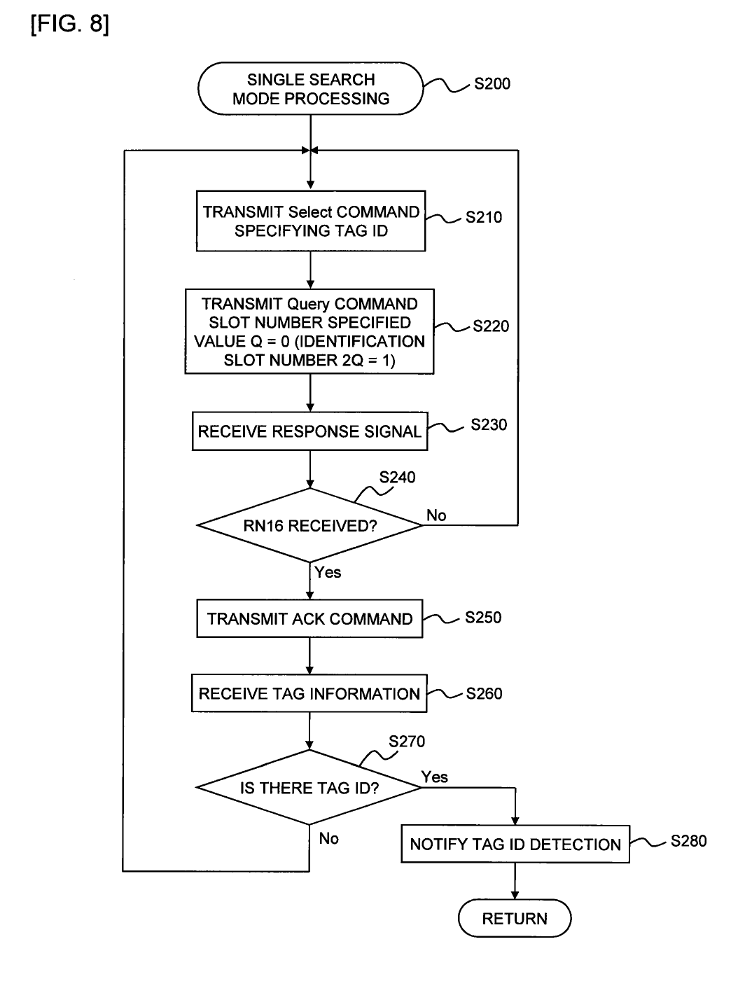

The single search mode as a single tag search mode is one of the plural types of application modes relating to the application forms of the reader/writer 100 and is a mode for making a search via radio communication for a single RFID tag circuit element To. The single search mode processing is processing corresponding to the single search mode. In the single search mode processing, the reader/writer 100 specifies one tag ID included in the list and inquires if the RFID tag circuit element To corresponding to the tag ID is present within the communicable area X or not (See FIG. 8, which will be described later).

On the other hand, at Step S80, if there are a plurality of tag IDs of the RFID tag circuit elements To registered in the list, the determination at Step S80 is not satisfied, and the routine goes to Step S90.

At Step S90, the control circuit 133 determines if associated information is made to correspond to the tag ID included in the list obtained at Step S10. The associated information is various types of information relating to an article on which the RFID tag circuit element To including the tat ID is placed such as the name of the article, for example. If the associated information is made to correspond, the determination at Step S90 is satisfied, the routine goes to Step S300, and the control circuit 133 executes multi search mode processing corresponding to the multi search mode, which will be described later. After that, this flow is finished.

The multi search mode as a plural tag search mode is one of the plural types of the application modes relating to the application forms of the reader/writer 100 and is a mode for making a sequential search via radio communication for a plurality of the RFID tag circuit elements To. The multi search mode processing is processing corresponding to the multi search mode. In the multi search mode processing, the reader/writer 100 specifies a plurality of tag IDs included in the list and inquires if the plurality of RFID tag circuit elements To corresponding to the tag IDs are present within the communicable area X or not.

On the other hand, at Step S90, if there is no associated information for the tag ID of the RFID tag circuit element To registered in the list, the determination is not satisfied, the routine goes to Step S400, and the control circuit 133 executes inventory mode processing corresponding to the inventory mode, which will be described later. After that, this flow is finished.

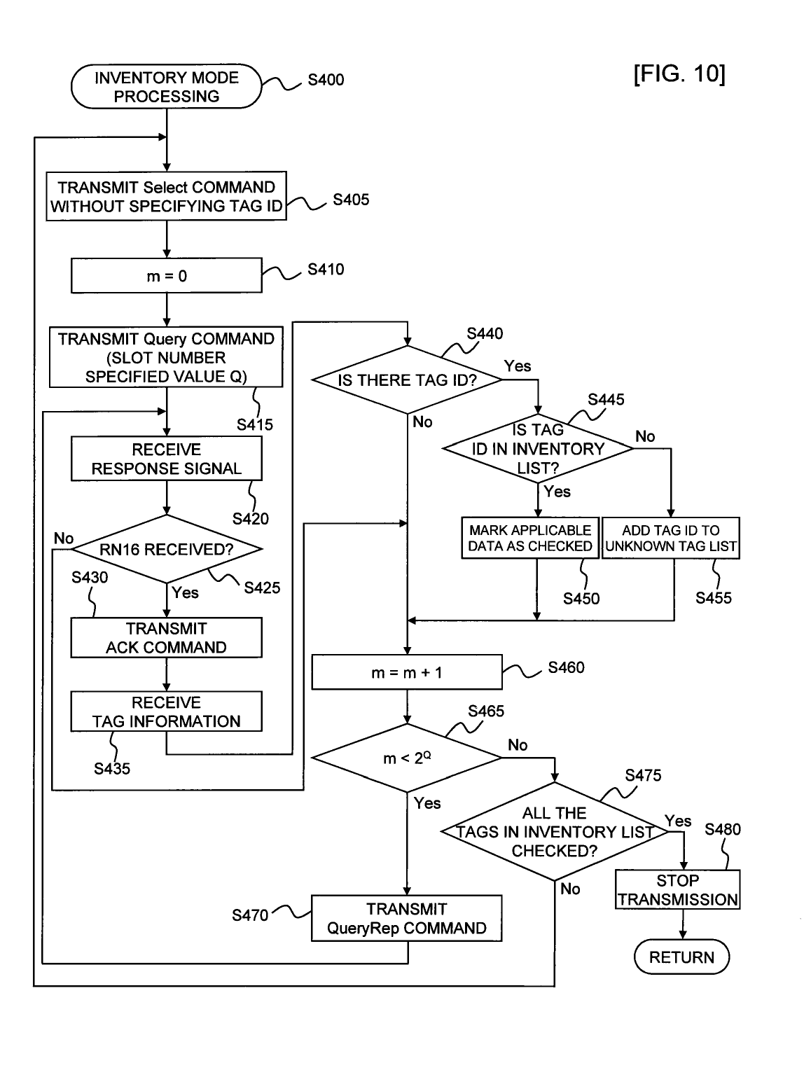

The inventory mode is one of the plural types of the application modes relating to the application forms of the reader/writer 100 and is a mode for checking presence of the RFID tag circuit elements To with the tag ID in the list via radio communication. The inventory mode processing is processing corresponding to the inventory mode. In this inventory mode processing, only if the plurality of RFID tag circuit elements To corresponding to the plurality of tag IDs included in the list can be detected or not is tried (See FIG. 10, which will be described later). Since in this mode, only presence matters, once all the RFID tag circuit elements To as a plurality of search targets with the tag IDs in the list are detected, the processing is finished.

The flowchart does not limit the present invention to the procedure shown in the flow but addition and deletion of the procedures and change of the order, for example, may be made within a range not departing from the gist or technical idea of the invention. For example, if the determination at Step S90 is satisfied, it may be so configured that the operator selects either one of the multi search mode and the single search mode. Also, if the determination at Step S90 is not satisfied, it may be so configured that the operator selects any one of the multi search mode, the single search mode, and the inventory mode.

In the above, Step S30, Step S50, Step S100, Step S200, Step S300, and Step S400 function as a mode setting part described in each claim. Also, Step S10 functions as a list obtainment part.

Also, Step S20 functions as an obtainment origin information detection part and also functions as an external obtainment determination part. Moreover, Step S70, Step S80, and Step S90 function as an identification information determination part.

Detailed contents of the list-up mode processing executed at Step S100 will be described using FIG. 7. First at Step S105, the control circuit 133 transmits the “Select” command signal without specifying the tag ID to the RFID tag circuit element To present within the communicable area X through the radio frequency circuit 131 and the reader antenna 111.

At Step S110, the control circuit 133 resets a value of a variable n for counting the identification slots to 0.

At Step S115, the control circuit 133 transmits the “Query” command signal similarly to the “Select” command signal. At this time, the slot number specified value is specified to Q. A time interval between a plurality of commands transmitted and received is adjusted as appropriate to a proper interval. Though not particularly described repeatedly below, the similar timing adjustment is made.

At Step S120, the control circuit 133 receives a response signal from the RFID tag circuit element To only for a predetermined time period through the reader antenna 111 and the radio frequency circuit 131.

After that, at Step S125, the control circuit 133 determines if the “RN16” command has been received as a response signal during the reception time period. If the “RN16” command has been received, the determination at Step S125 is satisfied, and the control circuit 133 considers that the responding RFID tag circuit element To is present in the identification slot, and the routine goes to Step S130.

At Step S130, the control circuit 133 transmits the “Ack” command with contents corresponding to a pseudo random number included in the “RN16” command received at Step S120 through the radio frequency circuit 131 and the reader antenna 111. After that, at Step S135, the control circuit 133 receives tag information from the RFID tag circuit element To through the reader antenna 111 and the radio frequency circuit 131. After that, at Step S140, the control circuit 133 determines if the tag ID is included or not in the received tag information, in other words, if reception of the tag ID has been successful or not. If the tag ID is not included, the determination at Step S140 is not satisfied, and the routine goes to Step S155, which will be described later. On the other hand, if the tag ID is included, the determination at Step S140 is satisfied, and the routine goes to Step S145.

At Step S145, the control circuit 133 determines if the tag ID whose obtainment was confirmed at Step S140 is included in the tag ID list or not. The tag ID list is prepared by the control circuit 133 of the reader/writer 100 by the list-up mode processing and is stored in the above-described memory 134, for example. If the tag ID is not included in the list of the tag IDs whose obtainment was confirmed at Step S140, the determination at Step S145 is not satisfied, the routine goes to Step S150, and the control circuit 133 adds the tag ID whose obtainment is confirmed at Step S140 to the tag ID list and stores it in the memory 134. On the other hand, if the tag ID whose obtainment was confirmed at Step S140 is included in the list, there is no need to add it to the list, and the routine goes to Step S155.

At the preceding Step S125, if the “RN16” command has not been received, the determination is not satisfied, the control circuit 133 considers that there is no RFID tag circuit element To responding in the identification slot, and the routine goes to Step S155.

At Step S155, the control circuit 133 adds 1 to the value of the variable n. After that, at Step S160, the control circuit 133 determines if the value of the variable n is smaller than 2^{Q}, that is, if the last identification slot has been finished or not. If the value of the variable n is smaller than 2^{Q}, the determination at Step S160 is satisfied, the control circuit 133 considers that the current reading trial processing has not been finished yet, and the routine goes to Step S165.

At Step S165, the control circuit 133 transmits the “QueryRep” command through the radio frequency circuit 131 and the reader antenna 111 and starts a new identification slot. After that, the routine returns to Step S120, and the similar procedure is repeated.

On the other hand, at Step S160, if the value of the variable n is 2^{Q} or more, the determination is not satisfied, and the routine goes to Step S170.

At Step S170, the control circuit 133 stops transmission of a command signal to the RFID tag circuit element To. As a result, the reading processing is stopped. Then, this routine is finished.

Detailed contents of the single search mode processing executed at Step S200 will be described using FIG. 8. In FIG. 8, first, at Step S210, the control circuit 133 transmits the “Select” command signal specifying the tag ID of the single RFID tag circuit element To (See Step S80 in FIG. 6) included in the tag ID list through the radio frequency circuit 131 and the reader antenna 111.

After that, at Step S220, the control circuit 133 transmits the “Query” command signal similarly to the “Select” command signal. At this time, the slot number specified value Q is specified to 0, and the identification slot number is 2⁰=1.

Then, at Step S230, the control circuit 133 receives a response signal from the RFID tag circuit element To for a predetermined period of time through the reader antenna 111 and the radio frequency circuit 131. After that, at Step S240, the control circuit 133 determines if the “RN16” command has been received or not as a response signal during the reception time.

If the “RN16” command has not been received yet, the determination at Step S240 is not satisfied. In this case, the control circuit 133 considers that there is no RFID tag circuit element To responding in the applicable identification slot, and the routine returns to Step S210. On the other hand, if the “RN16” command has been received, the determination at Step S240 is satisfied. In this case, the control circuit 133 considers that there is the RFID tag circuit element To responding in the applicable identification slot, and the routine goes to Step S250.

At Step S250, the control circuit 133 transmits an “Ack” command with the contents corresponding to a pseudo random number included in the “RN16” command received at Step S230 through the radio frequency circuit 131 and the reader antenna 111. After that, at Step S260, the control circuit 133 receives tag information from the RFID tag circuit element To through the reader antenna 111 and the radio frequency circuit 131. After that, at Step S270, the control circuit 133 determines if the tag ID is included in the received tag information or not, in other words, if reception of the tag ID has been successful or not. If the tag ID is not included, the determination at Step S270 is not satisfied, and the routine returns to the preceding Step S210. On the other hand, if the tag ID is included, the determination at Step S270 is satisfied, and the routine goes to Step S280.

At Step S280, the control circuit 133 transmits a control signal to the display part 121. As a result, the display part 121 displays that the tag ID of the RFID tag circuit element To as a search target has been detected. Then, this routine is finished.

In the above, an alarm is made at Step S280 only if the tag ID has been obtained, but not limited to that, the fact that the tag ID could not been obtained may be also notified.

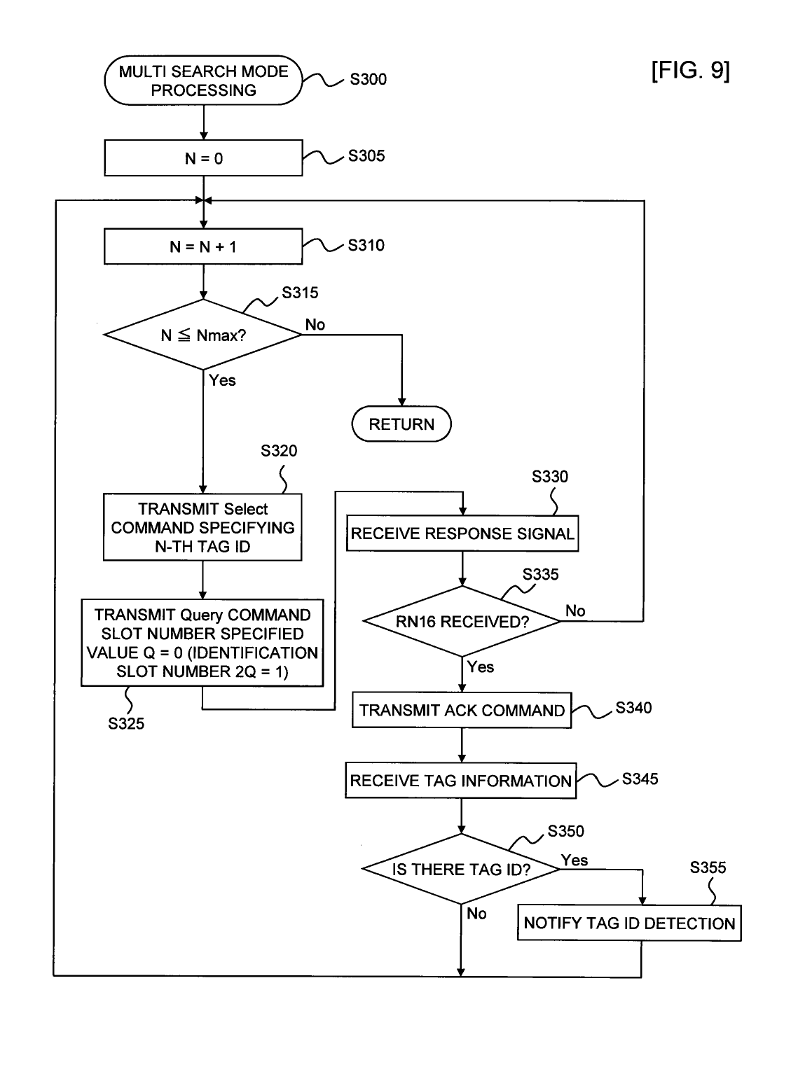

Detailed contents of the multi search mode processing executed at Step S200 will be described using FIG. 9. In FIG. 9, first, at Step S305, the control circuit 133 resets a value of a variable N for counting a plurality of tag IDs included in the tag ID list to 0.

At Step S310, the control circuit 133 adds 1 to the value of the variable N.

After that, at Step S315, the control circuit 133 determines if the value of the variable N is Nmax, which is the number of the tag IDs of the RFID tag circuit elements To as search targets included in the tag ID list, or less, in other words, if the search of the last tag ID in the tag ID list has not been finished yet. If the value of the variable N is larger than Nmax, the determination is not satisfied, that is, it is considered that the search of all the tag IDs in the tag ID list has been finished, and this routine is finished.

On the other hand, if the value of the variable N is not more than Nmax, the determination at Step S315 is satisfied. In this case, the control circuit 133 considers that the search processing of all the tag IDs in the tag ID list has not been finished yet, and the routine goes to Step S320.

At Step S320, the control circuit 133 specifies the N-th tag ID in the list and transmits the “Select” command signal to the RFID tag circuit element To corresponding to the applicable tag ID through the radio frequency circuit 131 and the reader antenna 111.

After that, at Step S325, the control circuit 133 transmits the “Query” command signal similarly to the “Select” command signal. At this time, the slot number specified value Q is specified to 0, and the identification slot number is 2⁰=1.

At Step S330, the control circuit 133 receives a response signal from the RFID tag circuit element To only for a predetermined period of time through the reader antenna 111 and the radio frequency circuit 131. After that, at Step S335, the control circuit 133 determines if the “RN16” command has been received or not as a response signal during the reception time.

If the “RN16” command has not been received yet, the determination at Step S330 is not satisfied. In this case, the control circuit 133 considers that there is no RFID tag circuit element To responding in the applicable identification slot and the routine returns to Step S310. If the “RN16” command has been received, the determination at Step S330 is satisfied, and the control circuit 133 considers that there is the RFID tag circuit element To responding in the applicable identification slot, and the routine goes to Step S340.

At Step S340, the control 133 transmits the “Ack” command with the contents corresponding to the pseudo random number included in the “RN16” command received at Step S330 through the radio frequency circuit 131 and the reader antenna 111. After that, at Step S345, the control circuit 133 receives the tag information from the RFID tag circuit element To through the reader antenna 111 and the radio frequency circuit 131. After that, at Step S350, the control circuit 133 determines if the tag ID is included in the received tag information or not, in other words, if the reception of the tag ID has been successful or not. If the tag ID is not included, the determination at Step S350 is not satisfied, and the routine returns to the preceding Step S310. On the other hand, if the tag ID is included, the determination at Step S350 is satisfied, and the routine goes to Step S355.

At Step S355, the control circuit 133 transmits a control signal to the display part 121. As a result, the display part 121 displays that the tag ID of the RFID tag circuit element To as a search target has been detected. Then, the routine returns to the preceding Step S310.

Detailed contents of the inventory mode processing executed at Step S400 will be described using FIG. 10. In FIG. 10, first, at Step S405, the control circuit 133 transmits the “Select” command signal without specifying the tag ID to the RFID tag circuit element To present in the communicable area X through the radio frequency circuit 131 and the reader antenna 111.

At Step S410, the control circuit 133 resets a value of a variable m for counting the identification slot to 0.

At Step S415, the control circuit 133 transmits the “Query” command signal similarly to the “Select” command signal. At this time, the slot number specified value is specified to Q.

After that, at Step S420, the control circuit 133 receives a response signal from the RFID tag circuit element To only for a predetermined period of time through the reader antenna 111 and the radio frequency circuit 131.

After that, at Step S425, the control circuit 133 determines if the “RN16” command has been received or not as a response signal during the reception time. If the “RN16” command has been received, the determination at Step S425 is satisfied, the control circuit 133 considers that there is the RFID tag circuit element To responding in the applicable identification slot, and the routine goes to Step S430.

At Step S430, the control circuit 133 transmits the “Ack” command with the contents corresponding to the pseudo random number included in the “RN16” command received at Step S420 through the radio frequency circuit 131 and the reader antenna 111. After that, at Step S435, the control circuit 133 receives the tag information from the RFID tag circuit element To through the reader antenna 111 and the radio frequency circuit 131. After that, at Step S440, the control circuit 133 determines if the tag ID is induced in the received tag information or not, in other words, if the reception of the tag ID has been successful or not. If the tag ID is not included, the determination at Step S440 is not satisfied, and the routine goes to Step S460, which will be described later. On the other hand, if the tag ID is included, the determination at Step S440 is satisfied, and the routine goes to Step S445.

At Step S445, the control circuit 133 determines if the tag ID whose obtainment was confirmed at Step S440 is included in the inventory list or not. This inventory list is the tag ID list including the tag ID of the RFID tag circuit element To disposed on each of the plurality of books S as targets of inventory.

If the tag ID whose obtainment was confirmed at Step S440 is included in the inventory list, the determination at Step S445 is satisfied, the routine goes to Step S450, the control circuit 133 checks the applicable tag ID as having been searched, and the routine goes to Step S460. On the other hand, if the tag ID whose obtainment was confirmed at Step S440 is not included in the inventory list, the determination at Step S445 is not satisfied, and the routine goes to Step S455. At Step S455, the control circuit 133 adds the tag ID whose obtainment was confirmed to an unknown tag list prepared in advance and has it stored in the memory 134, and the routine goes to Step S460.

At the preceding Step S425, if the “RN16” command has not been received, the determination is not satisfied, the control circuit 133 considers that there is no RFID tag circuit element To responding in the applicable identification slot, and the routine goes to Step S460.

At Step S460, the control circuit 133 adds 1 to the value of the variable m. After that, at Step S465, the control circuit 133 determines if the value of the variable m is smaller than 2^{Q}, that is, if the last identification slot has been finished or not. If the value of the variable is smaller than 2^{Q}, the determination at Step S465 is satisfied, the control circuit 133 considers that the current reading trial processing has not been finished yet, and the routine goes to Step S470.

At Step S470, the control circuit 133 transmits the “QueryRep” command through the radio frequency circuit 131 and the reader antenna 111 and starts a new identification slot. After that, the routine returns to Step S420, and the similar procedure is repeated.

On the other hand, at Step S465, if the value of the variable m is 2^{Q} or more, the determination is not satisfied, and the routine goes to Step S475.

At Step S475, the control circuit 133 determines if all the tag IDs included in the inventory list have been checked as having been searched at Step S450. If the tag ID which has not been checked yet remains in the inventory list, the determination at Step S475 is not satisfied, and the routine returns to the preceding Step S405. On the other hand, if all the tag IDs in the inventory list have been checked, the determination at Step S475 is satisfied, and the routine goes to Step S480.

At Step S480, the control circuit 133 stops transmission of the command signal to the RFID tag circuit element To. As a result, the reading processing is stopped. Then, this routine is finished.

As described above, in this embodiment, a plurality of application modes for different use forms of radio communication are prepared in advance in the reader/writer 100. If an operator is to conduct communication using the reader/writer 100, the control circuit 133 switches and sets a mode according to status information indicating the obtainment status of the tag IDs of the plurality of RFID tag circuit elements To at that time. Since the mode can be switched automatically according to various statuses, the operator can easily conduct radio communication in the optimal communication form. As a result, convenience can be improved.

Also, particularly in this embodiment, the tag ID list of the RFID tag circuit elements To as search targets is obtained. As a result, the search target can be specified and selected from the listed up RFID tag circuit elements To and radio communication can be conducted. Also, by obtaining the tag ID list, mode switching can be made according to obtainment origins of the tag ID list representing where the list is present or list contents such as the form of the tag ID of the RFID tag circuit element To included in the list.

Also, particularly in this embodiment, as the obtainment origin information when the tag ID list including the tag ID of the RFID tag circuit element To as a search target is obtained, it is detected whether the list was obtained through the network NW or from the memory 134 in the apparatus. As a result, mode switching can be made according to the obtainment origin of the list, and the radio communication can be conducted in the optimal communication form.

Also, particularly in this embodiment, at Step S20, it is determined if the list has been obtained from the database 300 outside the apparatus or not. As a result, the obtainment origin of the list can be detected.

Also, particularly in this embodiment, according to the obtainment origin information of the tag ID list as status information, switching and setting are made from a plurality of modes. As a result, according to the obtainment origin of the list, the mode can be switched and set, and the radio communication can be conducted in the optimal communication form.

Also, particularly in this embodiment, according to the obtainment origin information of the tag ID list as the status information, the plural types of specification modes relating to the operation specifications of the reader/writer 100, that is, either of the fixed mode or the handheld mode can be switched and set. As a result, according to the obtainment origin of the tag ID list, the specification mode can be switched, and radio communication can be made in the optimal communication form.

Also, particularly in this embodiment, as the specification mode, the handheld mode corresponding to the use in which the operator carries the reader/writer 100 for use and the fixed mode corresponding to the use in which the reader/writer 100 is placed at a fixed location are provided. As a result, according to the obtainment origin of the tag ID list, the handheld mode or the fixed mode can be selected and used. That is, if the tag ID list is obtained from the outside of the reader/writer 100 through the network NW, since it is likely that the operator places the reader/writer 100 at a fixed location and uses it, the mode is switched to the fixed mode, while if the list is obtained from the memory 134 inside the reader/writer 100, since it is likely that the operator carries the reader/writer 100 for use, the mode is switched to the handheld mode. As a result, radio communication can be conducted in the optimal communication form.

Also, particularly in this embodiment, the status of the tag ID included in the obtained tag ID list, that is, presence of associated information such as the number of tag IDs and article information, for example, is determined at Step S70, Step S80, and Step S90. As a result, the mode can be switched according to the status of the tag ID of the RFID tag circuit element To included in the tag ID list, and radio communication can be conducted in the optimal communication form.

Also, particularly in this embodiment, according to a determination result of the tag ID mode at Step S70, Step S80, and Step S90 as status information, the mode is switched from the plural modes and set. As a result, according to the tag ID status of the RFID tag circuit element To included in the tag ID list, the mode can be switched and set, and radio communication can be conducted in the optimal communication form.

Also, particularly in this embodiment, according to the status of the tag ID, the mode is switched and set from the plural types of application modes relating to the application forms of the reader/writer 100, that is, the list-up mode, the single search mode, the multi search mode, and the inventory mode. As a result, according to the tag ID status of the RFID tag circuit element To included in the tag ID list, the application mode is switched, and radio communication can be conducted in the optimal communication form.

That is, if the tag IDs of the plurality of RFID tag circuit elements To are included in the tag ID list, a smooth search can be made by switching to the multi search mode. Also, if only one tag ID of the RFID tag circuit element To is included in the tag ID list, a rapid search can be made by switching to the single search mode.

Also, particularly in this embodiment, the inventory mode and the list-up mode are provided as the application modes. As a result, according to the status of the tag ID of the RFID tag circuit element To included in the tag ID list, the inventory mode or the list-up mode can be selected and used. That is, if associated information such as an article name is not made correspond to the tag ID included in the tag ID list, by switching the mode to the inventory mode, presence of the RFID tag circuit element To included in the tag ID list can be smoothly searched. Also, if the tag ID is not included in the tag ID list, by switching the mode to the list-up mode, a smooth search can be made.

The present invention is not limited to the above-described embodiment but is capable of various variations within a range not departing from its gist and technical idea. The variations will be described below in order.

(1) If the latest tag ID list is to be detected:

In this variation, if a plurality of lists whose dates of preparation or update are varied in time are obtained, the obtainment origin information relating to the latest list is detected.

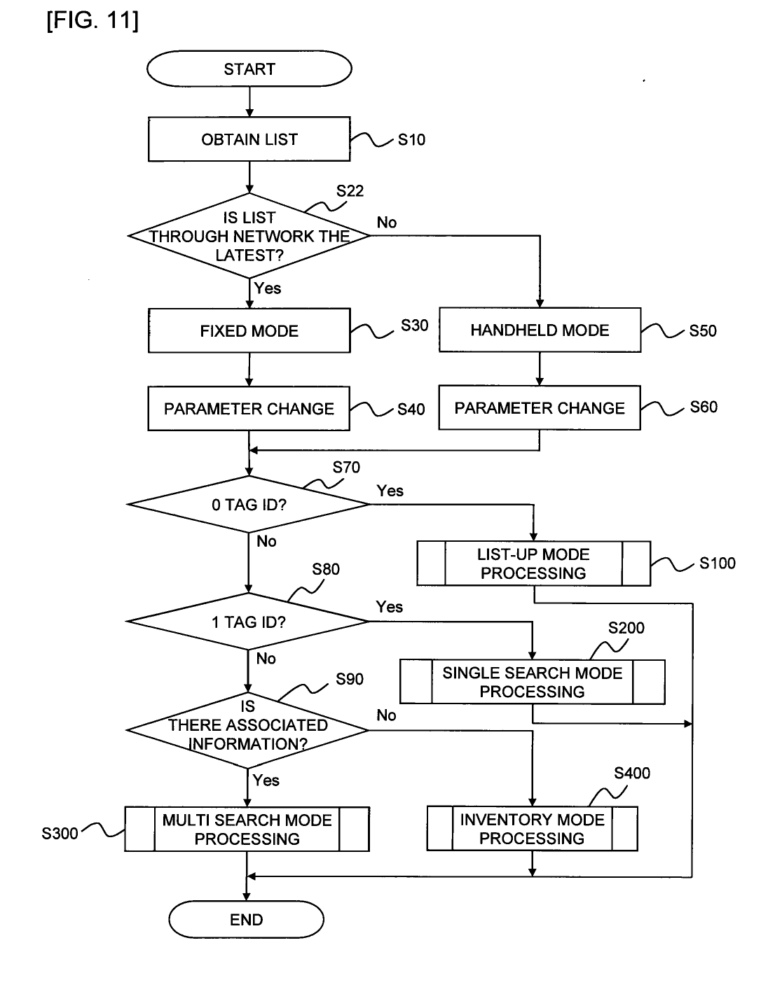

The control procedure executed by the control circuit 133 of the reader/writer 100 in this variation will be described referring to FIG. 11. FIG. 11 is a diagram corresponding to FIG. 6. The same reference numerals are given to the procedures equivalent to those in FIG. 6 and the description will be omitted.

First, at Step S10, the control circuit 133 obtains the tag ID list of the plurality of RFID tag circuit elements To as search targets. At this time, if the reader/writer 100 is in the handheld use state, similarly to the above, the memory 134 is searched and the tag ID list is obtained. On the other hand, if the reader/writer 100 is in the fixed use state, differently from the above-described embodiment, the control circuit 133 searches both the database 300 connected through the network NW and the memory 134 and obtains the tag ID list from the both.

After that, the routine goes to the newly provided Step S22, and the control circuit 133 determines if the list obtained through the network NW at Step S10 is the latest or not. If the reader/writer 100 is in the handheld use state, since the list has not been obtained through the network NW at Step S10, the determination at Step S22 is not satisfied, and the routine goes to Step S50. On the other hand, if the reader/writer 100 is in the fixed use state, if the tag ID list obtained from the database 300 through the network NW is newer than the tag ID list obtained from the memory 134, the determination at Step S22 is satisfied, and the routine goes to Step S30. Step S30 and Step S40 are the same as in FIG. 6. If the tag ID list obtained from the database 300 through the network NW is not newer than the tag ID obtained from the memory 134, the determination at Step S22 is not satisfied, and the routine goes to Step S50. Step S50 and Step S60 are the same as in FIG. 6.

After that, using the tag ID list determined as the latest at Step S22, that is, the tag ID list from the memory 134 in the case of the handheld use or the tag ID list from the network NW in the case of the fixed use, the procedures at Step S70 and after are executed. Since these procedures are the same as those in FIG. 6, the description will be omitted.

Step S22 functions as a first obtainment determination portion described in each claim and also functions as an obtainment origin information detection portion.

According to this variation, even if a plurality of new and old tag ID lists are both present in the database 300 connected through the network NW and the memory 134 in the reader/writer 100, the specification mode can be switched to the fixed mode or the handheld mode according to the obtainment origin of the latest list.

Also, according to this variation, if a plurality of lists whose dates of preparation or update are varied in time are obtained, the status of the tag ID relating to the latest list is determined. As a result, even if a plurality of new and old lists are both present, the application mode can be switched to any of the list-up mode, the single search mode, the multi search mode, and the inventory mode according to the status of the tag ID of the RFID tag circuit element To included in the latest list.

(2) If detection of the list obtainment origin is made both in and outside the apparatus:

In the above-described embodiment, at Step S20 in FIG. 6, only whether or not the tag ID list has been obtained through the network NW was determined, but not limited to that. That is, whether or not the tag ID list has been obtained from the memory 134 in the reader/writer 100 may be also determined.

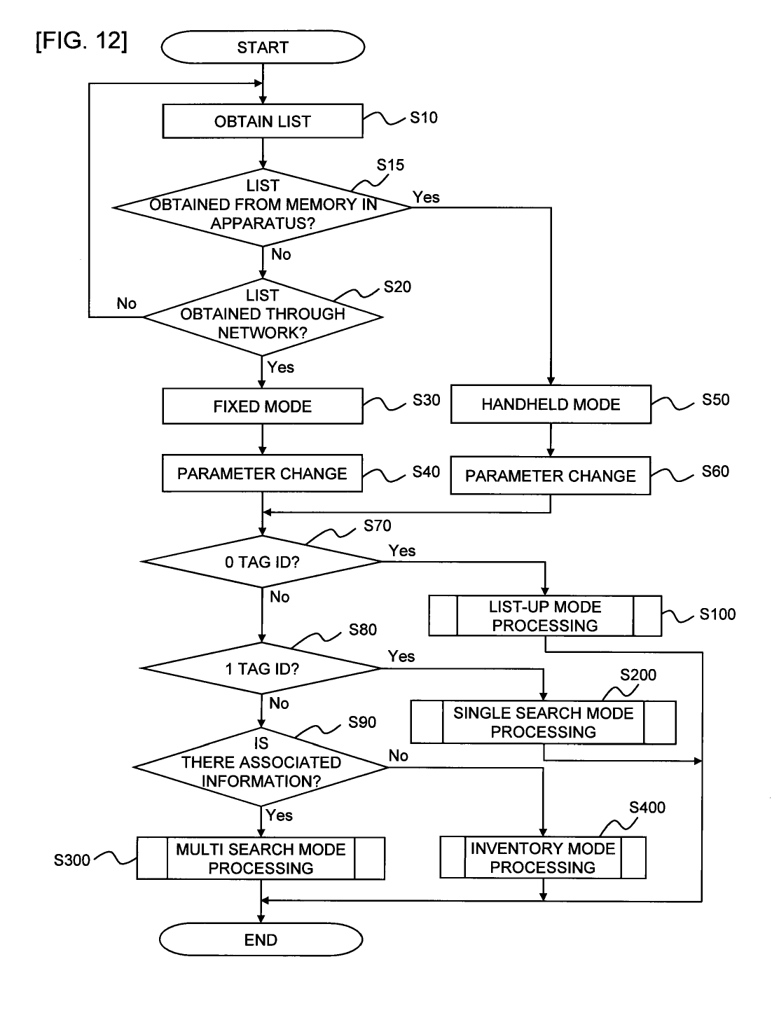

The control procedure the control circuit 133 of the reader/writer 100 in this variation executes will be described referring to FIG. 12. FIG. 12 is a diagram corresponding to FIG. 6. The same reference numerals are given to the procedures equivalent to those in FIG. 6 and the description will be omitted.

First, at Step S10, the control circuit 133 searches and obtains the tag ID list of the plurality of RFID tag circuit elements To as search targets. Specifically, similarly to FIG. 6, the control circuit 133 obtains the tag ID list from the memory 134 if the reader/writer 100 is in the handheld use state or from the database 300 if the reader/writer 100 is in the fixed use state.

After that, the routine goes to the newly provided Step S15, and the control circuit 133 determines if the tag ID list has been obtained from the memory 134 or not at Step S10. If the tag ID has been obtained from the memory 134, the determination at Step S15 is satisfied, and the routine goes to the above-described Step S50. On the other hand, if the tag ID list has not been obtained from the memory 134 but obtained from the database 300, the determination at Step S15 is not satisfied, and the routine goes to Step S20.

At Step S20, the control circuit 133 determines, similarly to FIG. 6, if the tag ID list has been obtained through the network NW at Step S10 or not. If the list has been obtained from the database 300 through the network NW, the determination at Step S20 is satisfied, and the routine goes to Step S30. On the other hand, if the tag ID list has not been obtained through the network NW, it is considered that obtainment of the list has failed, the routine returns to Step S10, and the list obtainment is performed again.

Since the subsequent procedures are the same as those in FIG. 6, the description will be omitted.

Step S15 functions as a second obtainment determination portion described in each claim, Step S20 functions as a first obtainment determination portion, and Step S15 and Step S20 function as the obtainment origin information detection portion.

In the variation described above, obtainment of the tag ID list from the memory 134 is first determined at Step S15 and then, list obtainment from the database 300 is determined at Step S20. As a result, in the case of the obtainment from the memory 134, there is no need to determine if the list was obtained through the network communication or not, and the obtainment origin information can be detected rapidly.

In the above, the list obtainment from the memory 134 was determined first, and then, the list obtainment from the database 300 was determined, but to the contrary, it may be so configured that the list obtainment from the database 300 is determined first and then, the list obtainment from the memory 134 is determined.

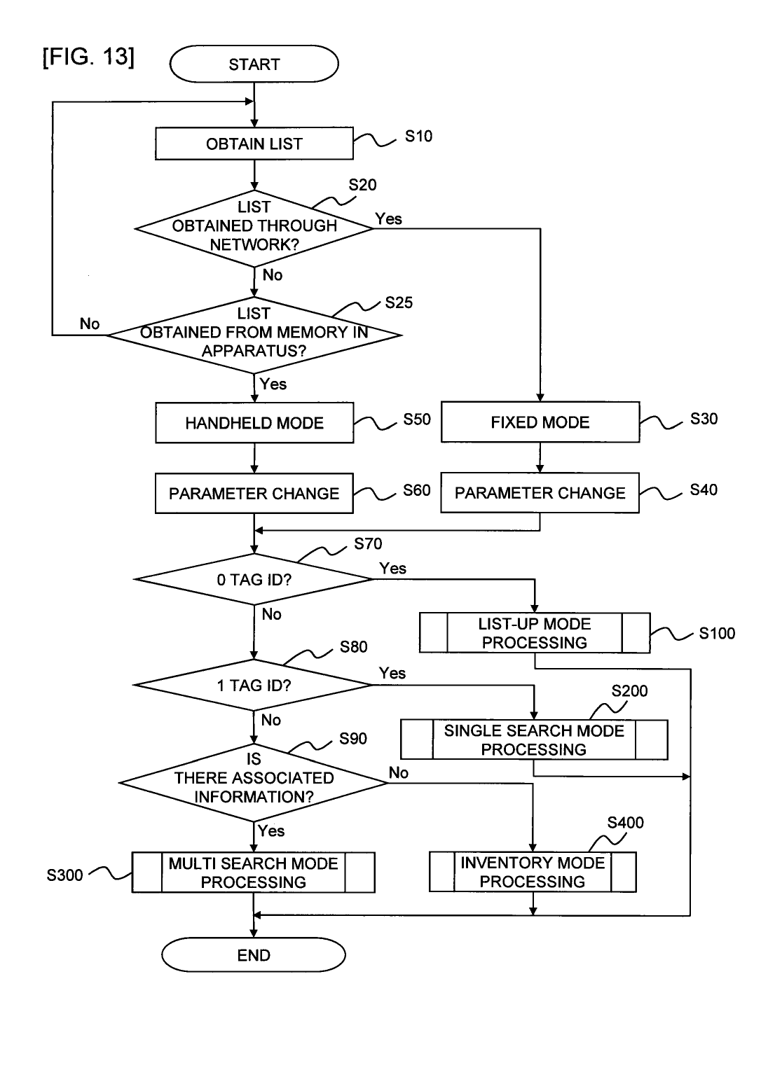

The control procedure the control circuit 133 of the reader/writer 100 in this variation executes will be described referring to FIG. 13. FIG. 13 is a diagram corresponding to FIG. 6. The same reference numerals are given to the procedures equivalent to those in FIG. 6 and the description will be omitted.

First, at Step S10, the control circuit 133 searches and obtains the tag ID list of the plurality of RFID tag circuit elements To as search targets. Similarly to the above, the control circuit 133 obtains the tag ID list from the memory 134 if the reader/writer 100 is in the handheld use state or from the database 300 if the reader/writer 100 is in the fixed use state.

At Step S20, the control circuit 133 determines if the tag ID list has been obtained from the database 300 through the network NW at Step S10 or not. If the list has been obtained through the network NW, the determination at Step S20 is satisfied, and the routine goes to Step S30. On the other hand, if the tag ID list has not been obtained through the network NW but obtained from the memory 134, the determination at Step S20 is not satisfied, and the routine goes to the newly provided Step S25.

At Step S25, the control circuit 133 determines if the tag ID list has been obtained from the memory 134 at Step S10 or not. If the list has been obtained from the memory 134, the determination at Step S25 is satisfied, and the routine goes to Step S50. On the other hand, if the tag ID list has not been obtained from the memory 134, it is considered that obtainment of the list has failed, and the routine returns to the preceding Step S10, and the list obtainment is performed again.

Since the subsequent procedures are the same as in FIG. 6, the description will be omitted.

Step S20 functions as the first obtainment determination portion described in each claim, Step S25 functions as the second obtainment determination portion, and Step S20 and Step S25 function as the obtainment origin information detection portion.

In the above-described variation, obtainment of the tag ID list from the database 300 is first determined and then, obtainment of the tag ID list from the memory 134 is determined. As a result, determination on whether or not the tag ID list has been obtained from the memory 134 does not have to be made in the case of the obtainment from the database 300, and obtainment origin information can be detected rapidly.

(3) Others

In the above, the mode of the reader/writer 100 is automatically switched by control of the control circuit 133 according to the status information, but not limited to that. That is, for example, it may be so configured that the proper plural modes corresponding to the list are displayed on the display part 121 of the reader/writer 100 in a selectable manner so that the operator can select and operate any one of the plural modes displayed using the operation part 122 in accordance with the display of the display part 121. The mode that can be selected and operated in this case may be the application mode, the specification mode or both the application mode and the specification mode. At this time, the control circuit 133 sets the mode according to the operation result by the operation part 122. By allowing the mode selection by the operator as above, a degree of freedom in mode switching is widened, and convenience can be further improved.

Also, in the above, the plurality of modes were switched according to the obtainment origin of the tag ID list or the status of the tag ID list, which is the status information indicating the obtainment status of the tag IDs of the plurality of RFID tag circuit elements To. At this time, as the status information, not limited to the above but other types of information may be used. For example, past use history information of the reader/writer 100 by the operator is stored in an appropriate storage device, that is, the database 300 or the memory 134, for example. Then, in the radio communication, the control circuit 133 functioning as a use history obtainment device obtains the use history information and switches and sets any of the plurality of modes according to the obtained information. The use history information includes a power, the number of retry times when the single RFID tag circuit element To is searched, a polarization face, and a location where the list was obtained, for example. Also, as the use history information, full use history including other reader/writers relating to a certain operator may be used or full use history of a plurality of operators relating only to the applicable reader/writer 100 may be used.

By obtaining the past use history information as above, the full use history including other reader/writers of a certain operator or the full use history in the applicable reader/writer 100 of a large number of operators can be obtained, for example. Then, by switching and setting the mode according to the history, the mode switching can be made according to a use trend or habit of each operator or a use trend or circumstances of an arranged location of the reader/writer 100, and the optimal communication can be conducted.

Also, other than those described above, method of the embodiments or each variation may be used in combination as appropriate.

Arrows shown in FIGS. 3A, 3B, and 4, for example, show an example of a flow of signals and do not limit the flow direction of the signals.

Also, flowcharts shown in FIGS. 6, 7, 8, 9, 10, 11, 12, and 13 do not limit the present invention to the procedures shown in the flows but addition and deletion or change in the order of the procedures, for example, may be made within a range not departing from the gist and technical idea of the present invention.

Though not specifically exemplified, the present invention should be put into practice with various changes made in a range not departing from its gist.

What is claimed is:

1. An apparatus for communicating with a radio frequency identification (RFID) tag comprising:
a radio communicating device configured to conduct radio communication with a plurality of RFID tag circuit elements respectively having an IC circuit part storing information and a tag antenna capable of transmission and reception of information; and
a mode setting portion capable of switching and setting from a plurality of application modes with use forms of said radio communication different from each other according to status information indicating a status with respect to an obtainment of identification information of the plurality of said RFID tag circuit elements in communication.

2. The apparatus according to claim 1, further comprising a list obtainment portion configured to obtain a list of identification information of the plurality of said RFID tag circuit elements as search targets.

3. The apparatus according to claim 2, further comprising an obtainment origin information detection portion configured to detect obtainment origin information when said list obtainment portion obtains said list.

4. The apparatus according to claim 3, wherein:
said obtainment origin information detection portion detects said obtainment origin information relating to the latest list when said list obtainment portion obtains a plurality of said lists whose dates of preparation or update are varied in time.

5. The apparatus according to claim 3, wherein:
said obtainment origin information detection portion has at least one of a first obtainment determination portion configured to determine if said list was obtained through network communication from a first storage device disposed outside said apparatus and a second obtainment determination portion configured to determine if said list was obtained from a second storage device disposed inside said apparatus.

6. The apparatus according to claim 5, wherein:
in said obtainment origin information detection portion, said second obtainment determination portion determines if said list was obtained from said second storage device, and if the determination of the second obtainment determination portion is not satisfied, then said first obtainment determination portion determines if said list was obtained through network communication from the first storage device.

7. The apparatus according to claim 5, wherein:
in said obtainment origin information detection portion, said first obtainment determination portion determines if said list was obtained through network communication from said first storage device, and if the determination of said first obtainment determination portion is not satisfied, then said second obtainment determination portion determines if said list was obtained from said second storage device.

8. The apparatus according to claim 3, wherein:
said mode setting portion switches and sets a mode among said plurality of modes according to said obtainment origin information detected by said obtainment origin information detection portion as said status information.

9. The apparatus according to claim 8, wherein:
said mode setting portion is configured to be capable of switching and setting the mode among plural types of specification modes relating to an operation specification of the apparatus according to said obtainment origin information.

10. The apparatus according to claim 9, wherein:
said mode setting portion switches and sets the mode into at least both of a handheld mode corresponding to a use carried by an operator and a fixed mode corresponding to a use fixed on a fixed location, as said specification mode.

11. The apparatus according to claim 2, further comprising an identification information determination portion configured to determine a status of said identification information included in said list obtained at said list obtainment portion.

12. The apparatus according to claim 11, wherein:
said identification information determination portion determines a status of said identification information relating to the latest list when the plurality of said lists whose dates of preparation or update is varied in time are obtained by said list obtainment portion.

13. The apparatus according to claim 11, wherein:
said mode setting portion switches and sets a mode among said plurality of modes according to a determination result of said identification information determination portion as said status information.

14. The apparatus according to claim 13, wherein:
said mode setting portion is configured to be capable of switching and setting the mode among plural types of application modes relating to application forms of the apparatus according to said determination result.

15. The apparatus according to claim 14, wherein:
said mode setting portion switches and sets the mode into at least both of a plural tag search mode configured to make sequential search via radio communication through said radio communicating device with a plurality of said RFID tag circuit elements and a single tag search mode configured to make a search via radio communication through said radio communicating device with one of said RFID tag circuit elements, as said application mode.

16. The apparatus according to claim 14, wherein:
said mode setting portion switches and sets the mode into at least both of an inventory mode configured to confirm presence via radio communication through said radio communicating device with said RFID tag circuit element registered in said list and a list-up mode configured to obtain and list up identification information via radio communication through said radio communicating device with said RFID tag circuit element not registered in said list, as said application mode.

17. The apparatus according to claim 2, further comprising:
a display device configured to display said plurality of modes determined as settable by said mode setting portion, in a selectable manner; and
an operating device configured to select any one of the plurality of modes corresponding to display on said display device, wherein
said mode setting portion sets said mode according to an operation result of selection by said operating device.

18. The apparatus according to claim 1, further comprising a use history obtainment device configured to obtain past use history information by an operator, wherein
said mode setting portion switches and sets a mode among said plurality of modes according to said use history information obtained by said use history obtainment device as said status information.
